(19) United States
(12) Patent Application Publication
(10) Pub. No.: US 2022/0112383 A1
(43) Pub. Date: Apr. 14, 2022

(54) Anti-Adhesive Coating

(71) Applicant: SEB S.A., Ecully (FR)

(72) Inventors: Romain Besnard, Couzon Au Mont D'or (FR); Aurelien Dubanchet, Gresy Sur Aix (FR); Laurent Caillier, Gresy Sur Aix (FR)

(73) Assignee: SEB S.A., Ecully (FR)

(21) Appl. No.: 17/421,076

(22) PCT Filed: Dec. 20, 2019
(86) PCT No.: PCT/EP2019/086568

§ 371 Date: Jul. 7, 2021

(30) Foreign Application Priority Data
Jan. 7, 2019 (FR) 1900124

(51) Int. Cl. C09D 7/40; C09D 7/61; C09D 127/18; B05D 7/00; B05D 5/08; A47J 36/02

(52) U.S. Cl. CPC C09D 7/69; C09D 7/61; C09D 127/18; C08K 2003/2227; B05D 5/083; A47J 36/025; B05D 7/57

(57) ABSTRACT

The present invention relates to a non-stick coating comprising a transparent finishing coat, said finishing coat comprising at least one thermostable resin and fillers whose d50 is greater than the average thickness of said finishing coat.

### TECHNICAL FIELD

The present invention relates to the field of non-stick coatings intended to be applied to articles, and more particularly to household articles, such as culinary articles or appliances.

### PRIOR ART

In the cookware industry, the mechanical durability of coatings based on thermostable resin, in particular based on polytetrafluoroethylene (PTFE), is one of the most important concerns. This durability is usually assessed by the appearance of metal scratches and wear on the coating resulting in a loss of non-stick properties. Furthermore, it is common to find article-specific decoration and/or functionality on the bottom of articles such as an optimal cooking temperature indicator. These attributes are usually covered by a clear PTFE finishing coat that ensures optimum non-stick properties. However, this does not provide lasting protection for the above attributes against the mechanical stresses inherent in the use of the article (abrasion, scratching, etc.). The use of composite coatings designed by incorporating reinforcing fillers is a technique well known to persons skilled in the art (U.S. Pat. Nos. 8,642,171, 8,728,993, 5,665,450) to improve abrasion resistance and delay the appearance of scratching. The above performance depends on the nature, size and concentration of fillers incorporated into the coating. McElwain et al. (“Effect of Particle Size on the Wear Resistance of Alumina-Filled PTFE Micro- and Nanocomposites”—Tribol. Trans. 2008,51(3), 247-253) explored in particular the effect of filler (or particle) size on abrasion performance. They show that it is possible to gain up to 2 orders of magnitude on the wear resistance for micrometric size fillers and almost 4 orders for nanometric size fillers. The disadvantage of incorporating reinforcing fillers in PTFE coatings is that it can, on the one hand, lead to a decrease in non-stick properties, and on the other hand, lead to a decrease in transparency. Indeed, this can lead to an increase in light scattering in the filled coat and alter the aesthetics of the coating depending on the nature, size and amount of fillers incorporated in the coating.

Document WO 2007/070601 describes coatings having a finishing coat comprising diamond particles. The use of such particles poses a problem in terms of the cost of manufacturing the product comprising the coating.

In the context of culinary articles, the use of reinforcing fillers in the top coats of the coating is very limited. Indeed, these modifications of optical properties may not be compatible with the implementation of decorations and functionalities under the protective finishing coat(s) in the bottom of the culinary articles to improve their attractiveness. To overcome these optical problems, the use of inorganic fillers of sizes smaller than 100 nm is known. However, the incorporation of this type of filler leads to a significant loss of the non-stick properties of the coating.

### DISCLOSURE OF THE INVENTION

It has therefore become necessary to propose coatings with improved durability under mechanical stress without altering the non-stick features and visual properties of these coatings.

The applicant has developed a non-stick coating comprising a finishing coat to overcome the above drawbacks.

The advantages of this non-stick coating are that said finishing coat has optical properties compatible with the presence of visual attributes in the coating and increases the durability of the coating against mechanical stresses, without degradation of the non-stick properties of the coating. The present invention thus relates to a non-stick coating comprising a transparent finishing coat, said finishing coat comprising at least one thermostable resin and fillers whose d50 is greater than the average thickness of said finishing coat.

The present invention also relates to an article comprising a support provided with the non-stick coating according to the invention.

“Finishing coat” (sometimes “finish”) is understood to mean, in the sense of the present invention, the final layer of the coating, i.e., the layer of the coating that is intended to be in contact with the external environment.

“Transparent coat” is understood to mean, in the sense of the present invention, a layer that allows light to pass through it in the entire visible range, i.e., it must have a direct transmittance greater than 90% and a total haze value less than 40%.

The transparent finishing coat of the coating according to the invention must have a direct transmittance greater than 90% and a total haze value less than 40%.

The finishing coat of the coating in accordance with the invention is easily differentiated from the layers on which it is deposited by cross-sectional observations under a scanning electron microscope (SEM) or optical microscope. By analysis of the microscopic images, the thickness of the finishing coat is measurable. The finishing coat thickness measurement is performed at 20 random points on the coating section. The average thickness of the finishing coat is obtained by averaging these 20 measurements.

Advantageously, the finishing coat has an average thickness of 2 to 40 μm, preferably 10 to 30 μm. The d50, also denoted dv50, is the 50th percentile of the particle size volume distribution, i.e., 50% of the volume represents particles that are less than or equal to the d50 and 50% of the particles that are greater than the d50. The dv50 is defined in a similar manner. The d50 is measured by laser particle sizing.

Advantageously, the fillers have a d50 at least 1.4 times greater, preferably at least 1.5 times greater, than the average thickness of said finishing coat. Preferentially, the fillers have a d50 that is at most 3 times greater, preferably 2 times greater, than the average thickness of said finishing coat.

If the d50 of the fillers is less than 1.4 times the average thickness of the finishing coat, the optimal anti-abrasion properties are no longer assured. Conversely, if the d50 of the fillers is greater than 3 times the thickness of the finishing coat, this leads to a loss of anti-abrasion properties of the coating.

Preferentially, the fillers have a d50 greater than 2 μm. Advantageously, the fillers have a d50 greater than 20 μm, and preferably greater than 30 μm.

Preferentially, the fillers have a d50 less than 120 μm. Advantageously, the fillers have a d50 less than 60 μm, and preferably less than 50 μm.

Advantageously, the fillers are mineral fillers with a Mohs hardness greater than or equal to 7. By way of fillers that can be used in the context of the present invention, particular mention may be made of metal oxides, metal carbides, metal oxy-nitrides, metal nitrides, and mixtures thereof. Preferably, the fillers are selected from alumina, silicon carbide, zirconia, tungsten carbide, boron nitride, quartz, and mixtures thereof. Advantageously, the fillers used are metal oxides, preferably selected from alumina, zirconia, quartz and mixtures thereof. Preferentially, the metal oxides are alumina.

According to an embodiment of the present invention, the finishing coat comprises from 0.5 to 20% fillers, more preferentially from 1 to 10%, percentages expressed as dry mass with respect to the total dry mass of the finishing coat.

The size, and thus the d50, as well as the concentration of the fillers in the finishing coat can be assessed by performing an observation with an optical microscope crossed with a scanning electron microscope (SEM) equipped with an EDS on the surface of the coating in accordance with the invention. Since the finishing coat in accordance with the invention is transparent, it is easy to see the fillers included in the finishing coat. A mapping on 1 cm² provides a representative observation of the sample. The chemical composition of each of the fillers is then determined by energy dispersive analysis using a scanning electron microscope (SEM) equipped with EDS. The particle size distribution is measured by computer and digital image processing. This allows determination of the d50 as well as the average volume of the fillers and thus determination of their concentration. The volume concentration of the fillers can be calculated from the ratio of the volume of the fillers to the sum of the volume of the fillers and the finishing coat. The mass concentration is then calculated, taking into account the density of the fillers and the finishing coat respectively. The finishing coat in accordance with the invention comprises at least one thermostable resin. In the context of the present invention, a thermostable resin is a resin that is resistant to at least 200° C.

Advantageously, the thermostable resin of the finishing coat is a fluorocarbon resin, preferably selected from polytetrafluoroethylene (PTFE), copolymers of tetrafluoroethylene and perfluoromethylvinylether (such as MFA) copolymers of tetrafluoroethylene and perfluoropropylvinylether (such as PFA), copolymers of tetrafluoroethylene and hexafluoropropylene (such as FEP) and mixtures thereof.

The non-stick coating in accordance with the invention may further comprise at least one primer coat (sometimes referred to as a “primer” or “tackifier”). This primer coat is intended to be in contact with the surface of the support of the article on which the coating will be deposited. Advantageously, this primer coat allows the coating to cling to the support.

The non-stick coating in accordance with the invention may also further comprise at least one intermediate coat (sometimes “midcoat”) between the primer coat and the finishing coat. The non-stick coating in accordance with the invention may further include attributes, such as an article-specific decoration or functionality such as an optimal cooking temperature indicator. These attributes are applied between the primer coat and the finishing coat if the coating does not include an intermediate coat, or between the intermediate coat and the finishing coat otherwise.

The present invention also relates to an article comprising a support provided with the non-stick coating in accordance with the invention.

Advantageously, the article in accordance with the invention is a domestic article, in particular a culinary article.

“Domestic article” is understood to mean, in the sense of the present invention, an object intended to ensure the domestic needs of everyday life, in particular an article intended to receive a heat treatment or intended to produce heat. In particular, it may be a culinary article or a household appliance.

“Intended to receive a heat treatment” is understood to mean, in the sense of the present invention, an object which is to be heated by an external heating system, in particular a culinary article such as frying pans, saucepans, sauté pans, woks, pancake pans, casseroles, pots, braising pans, stewpots, barbecue grills, baking pans, caquelons and which is capable of transmitting the heat energy provided by this external heating system to a material or food in contact with said object. The present invention therefore also relates to a culinary article comprising a support provided with the non-stick coating in accordance with the invention.

In particular, the culinary article in accordance with the invention comprises a support having an inner side for receiving food and an outer side for disposition toward a heat source, and a non-stick coating in accordance with the invention disposed on at least one of the two sides of the support.

“Intended to produce heat” is understood to mean, in the sense of the present of the present invention, a heating object with its own heating system, in particular a household appliance such as irons, hair straighteners, steam generators or electric cooking appliances such as a sauce maker. Generally, a portion of the article support is coated with the non-stick coating in accordance with the invention, but it may be contemplated that the entire article support is coated.

Advantageously, the support can be made of metallic material, glass, ceramic, terracotta or plastic. Preferably, the support can be metallic and can be made of aluminum or aluminum alloy, anodized or not, optionally polished, brushed, sandblasted or microblasted, or of steel optionally polished, brushed, sandblasted or microblasted, or of stainless steel optionally polished, brushed, sandblasted or microblasted, or of cast steel, aluminum or iron, or of copper optionally hammered or polished.

Preferably, the support may be metallic and may comprise alternating layers of metal and/or metal alloy, or is a foundry aluminum, aluminum or aluminum alloy dome lined with a stainless steel outer bottom.

### EXAMPLES

In the following examples and counterexamples, the average thickness of the finishing coats was assessed by scanning electron microscope (SEM) cross-sectional observations. The finishing coat thickness measurement was performed at 20 random points on the cross-sections of the coatings. The average finishing coat thickness was obtained by averaging these 20 measurements.

### Example 1: Coating in Accordance with the Invention Comprising a Finishing Coat Containing Alumina Fillers

A finish formulation was prepared from a dispersion of PTFE particles of about 200 nm in diameter. 2.5% by mass of angular alumina fillers with a d50 of 44 μm in powder form were added to the dispersion. The dry extract of the dispersion was fixed at 50% by mass. In order to keep this parameter fixed, the amount of water was adjusted.

This finish formulation was sprayed onto a shaped article (a pan) previously coated with two other coats, all of which were predominantly composed of PTFE: a black primer, an intermediate coat, and decorative and functional attributes (decoration and optimal cooking temperature indicator). The amount of finish formulation applied was adjusted to obtain an average measured thickness of 20±1 μm of the finishing coat after the article was fired for 11 min at 430° C.

After firing, a filler concentration of 5% by mass was obtained in relation to the total mass of the finishing coat (calculation made in relation to the theoretical dry extract of the finishing coat).

### Example 2: Coating in Accordance with the Invention Comprising a Finishing Coat Containing Alumina Fillers

A first finish formulation was prepared from a dispersion of PTFE particles of about 200 nm in diameter. 2.5% by mass of angular alumina fillers with a d50 of 44 μm in powder form were added to the dispersion. The dry extract of the dispersion was fixed at 50% by mass. In order to keep this parameter fixed, the amount of water was adjusted.

This first finish formulation was sprayed onto a shaped article (a pan) previously coated with two other coats, all of which were predominantly composed of PTFE: a black primer, an intermediate coat, and decorative and functional attributes (decoration and optimal cooking temperature indicator).

A second non-filled clear finish formulation was prepared from a dispersion of PTFE particles of about 200 nm in diameter. The dry extract of the dispersion was fixed at 50% by mass. In order to keep this parameter fixed, the amount of water was adjusted. This second finish formulation was then sprayed onto the first finish formulation.

The amount of formulation deposited was adjusted so as to obtain a measured average total thickness of 25±1 μm after the article was fired for 11 min at 430° C. and so that the first formulation represents 40% of the finishing coat and the second formulation represents 60% of the finishing coat.

After firing, a filler concentration of 2% by mass was obtained in relation to the total mass of the finishing coat (calculation made in relation to the theoretical dry extract of the finishing coat).

### Counter Example 1: Coating Comprising a Non-Filled Finishing Coat

A non-filled finish formulation was prepared from a dispersion of PTFE particles of about 200 nm in diameter. The dry extract of the dispersion was fixed at 50% by mass. In order to keep this parameter fixed, the amount of water was adjusted.

This finishing coat formulation was sprayed onto a shaped article (a pan) previously coated with two other coats, all of which were predominantly composed of PTFE: a black primer, an intermediate coat, and decorative and functional attributes (decoration and optimal cooking temperature indicator). The amount of finishing coat formulation applied was adjusted to obtain an average measured thickness of 10±1 μm of the finishing coat after the article was fired for 11 min at 430° C.

### Counter Example 2: Coating Comprising a Finishing Coat Containing Alumina Fillers

A finish formulation was prepared from a dispersion of PTFE particles of about 200 nm in diameter. 1% by mass of colloidal alumina fillers with a d50 of 200 nm were added to the dispersion. The dry extract of the dispersion was fixed at 50% by mass. In order to keep this parameter fixed, the amount of water was adjusted.

This finish formulation was sprayed onto a shaped article (a pan) previously coated with two other coats, all of which were predominantly composed of PTFE: a black primer, an intermediate coat, and decorative and functional attributes (decoration and optimal cooking temperature indicator).

The amount of finish formulation applied was adjusted to obtain an average measured thickness of 20±1 μm of the finishing coat after the article was fired for 11 min at 430° C. After firing, a filler concentration of 2% by mass was obtained in relation to the total mass of the finishing coat (calculation made in relation to the theoretical dry extract of the finishing coat).

### Counter Example 3: Coating Comprising a Finishing Coat Containing Alumina Fillers

A finish formulation was prepared from a dispersion of PTFE particles of about 200 nm in diameter. 2.5% by mass of angular alumina fillers with a d50 of 1 μm in powder form were added to the dispersion. The dry extract of the dispersion was fixed at 50% by mass. In order to keep this parameter fixed, the amount of water was adjusted.

This finish formulation was sprayed onto a shaped article (a pan) previously coated with two other coats, all of which were predominantly composed of PTFE: a black primer, an intermediate coat, and decorative and functional attributes (decoration and optimal cooking temperature indicator). The amount of finish formulation applied was adjusted to obtain an average measured thickness of 20±1 μm of the finishing coat after the article was fired for 11 min at 430° C.

After firing, a filler concentration of 5% by mass was obtained in relation to the total mass of the finishing coat (calculation made in relation to the theoretical dry extract of the finishing coat).

### Counter Example 3a: Coating Comprising a Finishing Coat Containing Alumina Fillers Whose d50 is 1.3 Times Greater than the Thickness of the Finishing Coat

A finish formulation was prepared from a dispersion of PTFE particles of about 200 nm in diameter. 2.5% by mass of angular alumina fillers with a d50 of 26 μm in powder form were added to the dispersion. The dry extract of the dispersion was fixed at 50% by mass. In order to keep this parameter fixed, the amount of water was adjusted.

This finish formulation was sprayed onto a shaped article (a pan) previously coated with two other coats, all of which were predominantly composed of PTFE: a black primer, an intermediate coat, and decorative and functional attributes (decoration and optimal cooking temperature indicator). The amount of finish formulation applied was adjusted to obtain an average measured thickness of 20±1 μm of the finishing coat after the article was fired for 11 min at 430° C.

The d50 of the alumina filler is therefore 1.3 times the thickness of the finishing coat.

After firing, a filler concentration of 5% by mass was obtained in relation to the total mass of the finishing coat (calculation made in relation to the theoretical dry extract of the finishing coat).

### Counter Example 5: Coating Comprising a Finishing Coat Containing Alumina Fillers

A finish formulation was prepared from a dispersion of PTFE particles of about 200 nm in diameter. 2.5% by mass of angular alumina fillers with a d50 of 44 μm in powder form were added to the dispersion. The dry extract of the dispersion was fixed at 50% by mass. In order to keep this parameter fixed, the amount of water was adjusted.

This finish formulation was sprayed onto a shaped article (a pan) previously coated with two other coats, all of which were predominantly composed of PTFE: a black primer, an intermediate coat, and decorative and functional attributes (decoration and optimal cooking temperature indicator). The amount of finish formulation applied was adjusted to obtain an average measured thickness of 40±1 μm of the finishing coat after the article was fired for 11 min at 430° C.

The d50 of the alumina filler is therefore 1.1 times the thickness of the finishing coat. After firing, a filler concentration of 5% by mass was obtained in relation to the total mass of the finishing coat (calculation made in relation to the theoretical dry extract of the finishing coat).

### Counter Example 6: Coating Comprising a Finishing Coat Containing Alumina Fillers Whose d50 is 3.2 Times the Thickness of the Finishing Coat

A finish formulation was prepared from a dispersion of PTFE particles of about 200 nm in diameter. 2.5% by mass of angular alumina fillers with a d50 of 64 μm in powder form were added to the dispersion. The dry extract of the dispersion was fixed at 50% by mass. In order to keep this parameter fixed, the amount of water was adjusted.

This finish formulation was sprayed onto a shaped article (a pan) previously coated with two other coats, all of which were predominantly composed of PTFE: a black primer, an intermediate coat, and decorative and functional attributes (decoration and optimal cooking temperature indicator). The amount of finish formulation applied was adjusted to obtain an average measured thickness of 20±1 μm of the finishing coat after the article was fired for 11 min at 430° C.

The d50 of the alumina filler is therefore 3.2 times the thickness of the finishing coat.

After firing, a filler concentration of 5% by mass was obtained in relation to the total mass of the finishing coat (calculation made in relation to the theoretical dry extract of the finishing coat).

Results

Scratch Test, Non-Stick Test and Wear Coefficient

This test assesses the resistance of the coating to the action of an abrasive pad applied to its surface and the non-stick drop of this coating by a milk carbonization test after it has been subjected to the abrasion cycle. It is based on a normative test: NF D 21-511 with adapted particularities.

The apparatus used is an abrasion tester with a horizontal movement. A fixed arm supports a rectangular pad of dimensions 70±5 mm×30±5 mm, on which is placed an abrasive pad of the same size, and includes a tare allowing the application of a load of 21 N (including the weight of the lever arm). The abrasive moves at a speed of 33 back and forth movements per minute. The abraded surface is 70 mm×130 mm, i.e., a stroke of 100 mm. After 1000 abrasion cycles (i.e., 1000 back and forth movements of the abrasive), change in the non-stick properties is assessed after carbonization of a film of milk.

The test is stopped at the appearance of a scratch or a loss of non-stick properties (milk irreversibly stuck even after cleaning).

The effect of the fillers in the coatings on their mechanical performance was also assessed by determining the coating thickness removed per abrasion cycle. This is expressed as an abrasion rate v (or damaged volume) described by the formula Math 1 in which (t⁰) and (t^{abr}) represent respectively the coating thickness before and after abrasion, Sab the abraded surface and A the number of abrasion cycles undergone (here 1000 cycles). The operation is repeated 3 times per configuration.

$$v = \frac{( {t}^{0} - {t}^{abr} ) \cdot {S}_{ab}}{A} \qquad [ Math 1 ]$$

Then, the Schimtz relation is used to find the wear coefficient K (mm³/N·m) and is described by the formula Math 2 in which the damaged volume v is proportional to K, to the modulus of the normal force ∥\vec{F_{N}}∥ (21 N) and to the distance traveled d (i.e., 200 m).

v=K·∥F_{N}∥·d [Math 2]

Visual Observation

A visual observation was conducted of each article in Examples 1 and 2 and Counterexamples 1 through 6. The visual observation was rated as “good” in cases where the decorative and functional attributes were not obscured by the finishing coat (no loss of detail, no loss of color) and “poor” in cases where they were not.

Transmittance and Total Haze Value

To evaluate the optical properties of the finishing coats, measurements were made using a Haze-gard i with standard ASTM D1003.

In order to make these measurements, the finish formulations in the above examples and counterexamples were each applied directly to a smooth enameled plate. The amount of finish formulation applied was adjusted to obtain the same average finishing coat thicknesses as the examples and counterexamples, after firing the plate for 11 min at 430° C. The resulting films were peeled off the plates and analyzed.

To be aesthetically appealing and to be compatible with the presence of decorative and functional attributes (such as decoration and/or an optimal cooking temperature indicator), a coating must contain a finishing coat with a direct transmittance greater than 90% and a total haze value less than 40%.

TABLE 1

| | Wear | | Non- | Visual | Direct | |
|---|---|---|---|---|---|---|
| Examples | mm³/ | Scratch | stick | obser- | transmittance | Haze |
| Unit | N · m | cycles | test | vation | % | % |
| 1 | 1 · 10⁻⁴ | 80000 | ok | good | 96 | 29 |
| 2 | 1 · 10⁻⁴ | 100000 | ok | good | 96 | 24 |

TABLE 2

| Counter- | Wear | | Non- | Visual | Direct | |
|---|---|---|---|---|---|---|
| examples | mm3/ | Scratch | stick | obser- | transmittance | Haze |
| Unit | N · m | cycles | test | vation | % | % |
| 1 | 6 · 10⁻³ | 1500 | ok | good | 96 | 21 |
| 2 | 5 · 10⁻³ | 3000 | ok | bad | 80 | 60 |
| 3 | 3 · 10⁻³ | 3000 | ok | bad | 88 | 52 |
| 3a | 3 · 10⁻³ | 3000 | ok | bad | 88 | 52 |
| 5 | — | — | ok | bad | 80 | 60 |
| 6 | 1 · 10⁻⁴ | >100000 | bad | good | 94 | 28 |

1. A non-stick coating comprising a transparent finishing coat, said finishing coat comprising at least one thermostable resin and fillers whose d50 is at least 1.4 times greater than the average thickness of said finishing coat and at most 3 times greater than the average thickness of said finishing coat, and wherein the fillers are metal oxides.

2. The coating according to claim 1, wherein the fillers have a d50 greater than 20 μm.

3. The coating according to claim 1, wherein the fillers have a d50 less than 60 μm.

4. The coating according to claim 1, wherein the finishing coat comprises from 0.5 to 20% fillers, percentages expressed by mass with respect to the total mass of the finishing coat.

5. The coating according to claim 1, wherein characterized in that the fillers are mineral fillers with a Mohs hardness greater than or equal to 7.

6. The coating according to claim 1, wherein the metal oxides are selected from alumina, zirconia, quartz, or mixtures thereof.

7. The coating according to claim 6, wherein the metal oxides are alumina.

8. The coating according to claim 1, wherein the finishing coat has an average thickness of 2 to 40 μm.

9. The coating according to claim 1, wherein the thermostable resin is a fluorocarbon resin.

10. An article comprising a support provided with the non-stick coating according to claim 1.

11. The coating according to claim 8, wherein the finishing coat has an average thickness of 10 to 30 μm.

12. The coating according to claim 9, wherein the thermostable resin is selected from polytetrafluoroethylene (PTFE), copolymers of tetrafluoroethylene and perfluoromethylvinylether (such as MFA), copolymers of tetrafluoroethylene and perfluoropropylvinylether (such as PFA), copolymers of tetrafluoroethylene and hexafluoropropylene (such as FEP) or mixtures thereof.

13. The coating according to claim 1, wherein the fillers have a d50 greater than 20 μm and less than 60 μm, the finishing coat comprises from 0.5 to 20% fillers, percentages expressed by mass with respect to the total mass of the finishing coat and the metal oxides are selected from alumina, zirconia, quartz, or mixtures thereof.
